(19) United States
(12) Patent Application Publication
(10) Pub. No.: US 2024/0428664 A1
(43) Pub. Date: Dec. 26, 2024

(54) CURRENCY PROCESSING DEVICE

(71) Applicant: Glory Ltd., Himeji-shi (JP)

(72) Inventors: Daisuke MORIMOTO, Himeji-shi (JP); Masayuki KANAGAWA, Himeji-shi (JP); Yutatsu IWAI, Himeji-shi (JP)

(73) Assignee: Glory Ltd., Himeji-shi (JP)

(21) Appl. No.: 18/820,346

(22) Filed: Aug. 30, 2024

Related U.S. Application Data
(63) Continuation of application No. PCT/JP2023/005897, filed on Feb. 20, 2023.

(30) Foreign Application Priority Data
Mar. 4, 2022 (JP) 2022-033799

(51) Int. Cl. G07G 1/12; G06F 3/14; G07D 11/16

(52) U.S. Cl. CPC G07G 1/12; G06F 3/14; G07D 11/16

(57) ABSTRACT

The present invention provides a currency processing device including: an operation part that accepts operations performed by a user; an operation mode switching part that switches between a manned mode in which a store clerk is allowed to perform settlement processing, and a self-mode in which a customer is allowed to perform settlement processing; and an operation control part that performs control so that operations are accepted in the operation part in the manned mode, and operations are not accepted in the operation part in the self-mode.

### CROSS-REFERENCE TO RELATED APPLICATIONS

The present application is a continuation of PCT/JP2023/005897, filed Feb. 20,2023, which claims priority to JP 2022-033799, filed Mar. 4, 2022, and the contents of each of which are incorporated by reference in their entirety.

### TECHNICAL FIELD

The present invention relates to a currency processing device.

### BACKGROUND ART

In the past, in commercial facilities such as supermarkets and convenience stores, self-checkout systems in which customers themselves read product bar codes with currency processing devices and perform settlement processing, and semi-self-checkout systems in which store clerks at the commercial facilities read product bar codes with bar-code readers and customers perform the settlement processing with checkout machines have been introduced. Then, currency processing devices that can be used both for self-checkout registers used in these self-checkout systems and semi-self-checkout systems, and for manned registers that store clerks read product bar codes and perform settlement processing have been proposed.

For example, there is known a currency processor that includes: a depositing part for receiving currency; a conveyance part for conveying currency received in the depositing part; an identification and counting part for identifying and counting the currency received in the depositing part; a storage part for storing the currency conveyed by the conveyance part; and a control part for controlling the currency processor in at least a first processing mode for identifying and counting the currency received in the depositing part by the identification and counting part during standby and a second processing mode for forcedly returning the currency received in the depositing part during standby. The first processing mode and the second processing mode can be switched. In addition, there is known the currency processor includes a display part that performs display in a first display mode in the first processing mode, and in a second display mode different from the first display mode in the second processing mode.

### SUMMARY

The present invention completed under the above-described object provides a currency processing device including: an operation part accepting an operation by a user; an operation mode switching part switching between a first mode in which a store clerk is allowed to perform settlement processing, and a second mode in which a customer is allowed to perform the settlement processing; and an operation control part performing control to accept the operation to the operation part in the first mode and not to accept the operation to the operation part in the second mode.

### BRIEF DESCRIPTION OF DRAWINGS

FIG. 1 is a diagram showing an example of a schematic configuration of a currency processing system related to a first exemplary embodiment;

FIG. 2 is a diagram showing an example of a schematic configuration of a currency processing device;

FIG. 3 is a block diagram showing a functional configuration of the currency processing device;

FIG. 4A is a diagram showing an example of a standby screen in a manned mode, and

FIG. 4B is a diagram showing an example of a standby screen in a self-mode;

FIG. 5A is a diagram showing an example of a deposit screen in the manned mode, and FIG. 5B is a diagram showing an example of a deposit screen in the self-mode;

FIG. 6A is a diagram showing an example of a withdrawal screen in the manned mode, and FIG. 6B is a diagram showing an example of a withdrawal screen in the self-mode;

FIG. 7A is a diagram showing an example of an abnormality notification screen in the manned mode, and FIG. 7B is a diagram showing an example of an abnormality notification screen in the self-mode;

FIG. 8 is a block diagram showing an example of a functional configuration of a currency processing device related to a second exemplary embodiment;

FIG. 9A is a diagram showing an example of a withdrawal screen in a manned mode, and FIG. 9B is a diagram showing an example of a withdrawal screen in a self-mode.

FIG. 10 is a block diagram showing an example of a functional configuration of a currency processing device related to a third exemplary embodiment; and

FIG. 11A is a diagram showing an example of a withdrawal screen in a manned mode, and FIG. 11B is a diagram showing an example of a withdrawal screen in a self-mode.

### DESCRIPTION OF EMBODIMENTS

With the technology known in public, operation to an operation part is effective whether it is used as a self-checkout register or as a manned register; therefore, when it is used as the self-checkout register, a measure must be provided to prevent the customer from operating the operation part. As the measure to prevent operation of the operation part, for example, a cover for the operation part could be provided, but the cost of the product would be high by providing the cover.

The present invention has been made in view of such a point and an object of the present invention is to provide a currency processing device capable of inexpensively realizing that operations of an operating unit by a customer are not effective when used as a self-checkout register or semi-self-checkout register.

The present invention completed under the above-described object provides a currency processing device including: an operation part configured to accept an operation by a user; an operation mode switching part configured to switch between a first mode in which a store clerk is allowed to perform settlement processing, and a second mode in which a customer is allowed to perform the settlement processing; and an operation control part configured to perform control to accept the operation to the operation part in the first mode and not to accept the operation to the operation part in the second mode.

Here, the currency processing device may include a management mode switching part configured to switch to a management mode allowing an administrator to manage, and, in a case of the management mode, the operation control part may control to accept the operation to the operation part even in a case of the second mode.

In addition, the currency processing device may further include a display part configured to display information and a display control part configured to control to cause the display part to display information in the first mode and not to display information in the second mode.

Moreover, when an abnormality occurs, the display control part may cause the display part to display occurrence of the abnormality in a different manner between the first mode and the second mode.

Furthermore, when performing deposit processing or withdrawal processing, the display control part may cause the display part to display guidance on at least one of deposit and withdrawal in a different manner between the first mode and the second mode.

In addition, when performing deposit processing or withdrawal processing, the display control part may cause the display part to display guidance on one of deposit and withdrawal in a different manner between the first mode and the second mode and to display guidance on the other in the same manner in the first mode and in the second mode.

Moreover, the currency processing device may further include: a currency acceptance part configured to drive a feeding belt to accept currency; and a processing control part configured to intermittently drive the feeding belt when performing deposit processing in the second mode.

Furthermore, the currency processing device may further include: a sensor configured to detect that currency has been inserted; a transport part configured to transport currency; and a processing control part configured to control the transport part to dispense currency when the sensor detects that the currency has been inserted during standby.

In addition, the currency processing device may further include: depositing part configured to receive currency; a transport part configured to transport currency; and a processing control part configured to control, in the second mode, the transport part to dispense currency that has further been received after deposit is confirmed.

Moreover, the management mode switching part may switch to the management mode in response to a position where a key is inserted and rotated.

Furthermore, the operation mode switching part may switch between the first mode and the second mode based on a preset setting.

The present invention completed under the above-described object further provides a currency processing device including: an operation part configured to accept an operation by a user; an operation mode switching part configured to switch between a first mode in which a store clerk is allowed to perform settlement processing, and a second mode in which a customer is allowed to perform the settlement processing; an operation control part configured to control to accept the operation to the operation part in the first mode and not to accept the operation to the operation part in the second mode; a display part configured to display information; and a display control part configured to control to cause the display part to display information in the first mode and not to display information in the second mode.

The present invention completed under the above-described object still further provides a currency processing device including: an operation part configured to accept an operation by a user; an operation mode switching part configured to switch between a first mode in which a store clerk is allowed to perform settlement processing, and a second mode in which a customer is allowed to perform the settlement processing; an operation control part configured to control to accept the operation to the operation part in the first mode and not to accept the operation to the operation part in the second mode; a depositing part configured to receive currency; a transport part configured to transport currency; and a processing control part configured to control, in the second mode, the transport part to dispense currency that has further been received after deposit is confirmed.

According to the present invention, it is possible to inexpensively realize that operations of an operating unit by a customer are not effective when the currency processing device is used as a self-checkout register or semi-self-checkout register.

Hereinafter, exemplary embodiments will be described in detail with reference to attached drawings.

### First Exemplary Embodiment

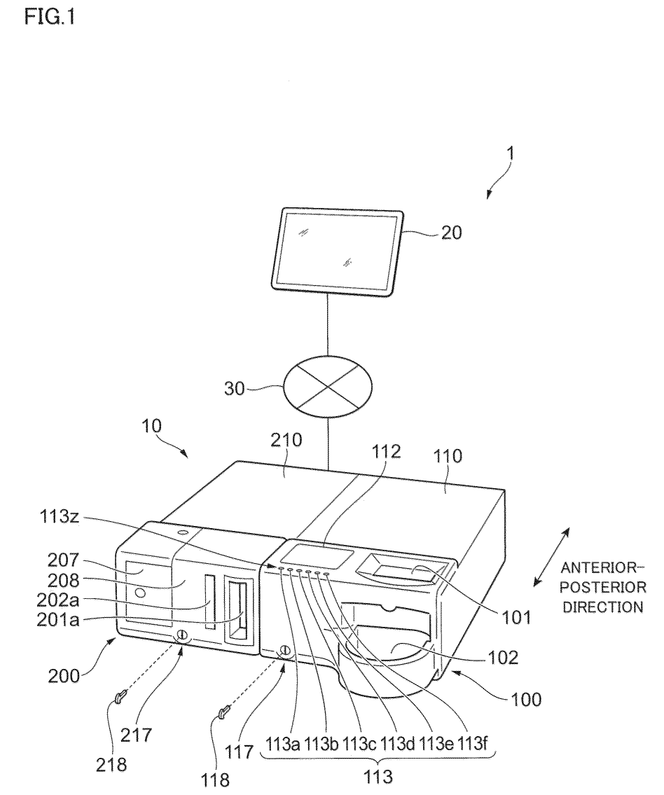

FIG. 1 is a diagram showing an example of a schematic configuration of a currency processing system 1 (hereinafter, simply referred to as a “system 1” in some cases) related to a first exemplary embodiment.

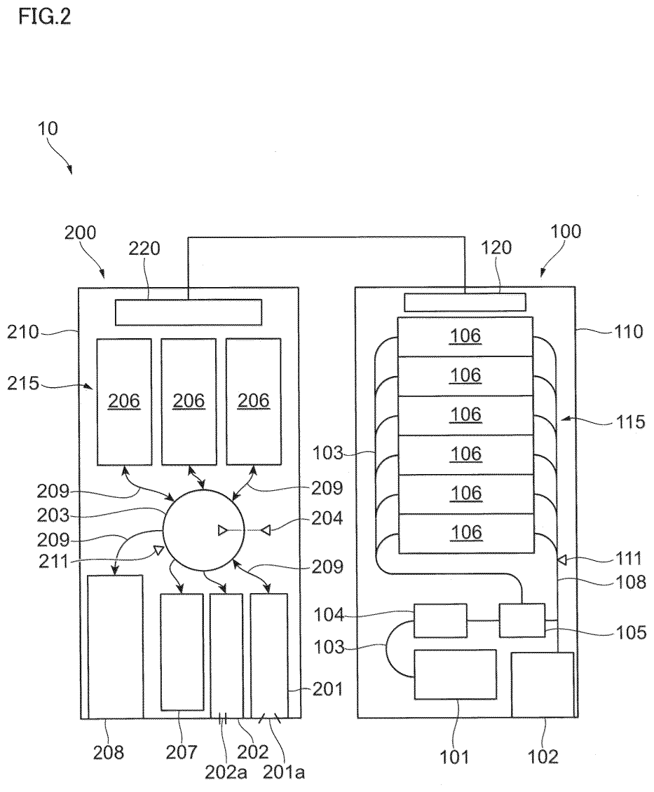

FIG. 2 is a diagram showing an example of a schematic configuration of a currency processing device 10.

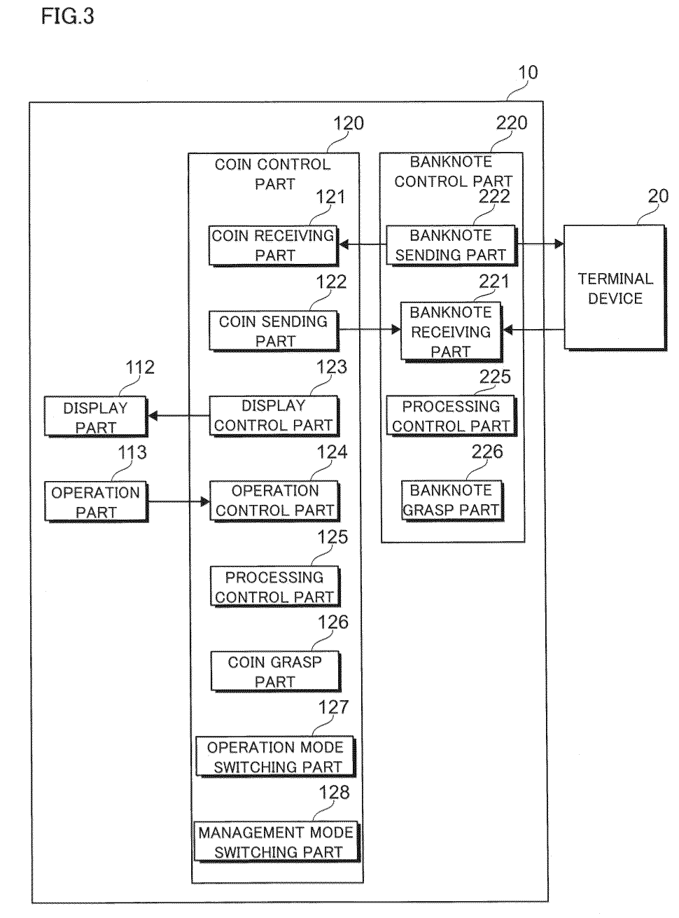

FIG. 3 is a block diagram showing a functional configuration of the currency processing device 10.

The system 1 includes the currency processing device 10 and a terminal device 20.

The terminal device 20 can be exemplified by a fixed-type terminal such as a POS register including an operation part operated by a user, a display part displaying processing statuses of currency in the currency processing device 10, a printing part issuing receipts, etc. In addition, the terminal device 20 is not limited to the fixed type, but may also be a portable terminal such as a tablet terminal, a tablet PC, a personal digital assistant (PDA), a note PC, a multi-functional portable phone (a so-called smartphone), etc.

The currency processing device 10 and the terminal device 20 can be exemplified as being installed at checkout counters in commercial facilities or restaurants.

The currency processing device 10 and the terminal device 20 can communicate with each other via a network 30. The network 30 is not particularly limited as long as it is a communication network used for data communication between devices, and can be exemplified as being a LAN (Local Area Network). It does not matter that the communication line used for data communication may be wired or wireless, or may be used together. A wireless LAN can be exemplified as, for example, Wi-Fi (registered trademark) and Bluetooth (registered trademark).

Here, when a customer purchases a product at a commercial facility, the settlement processing is carried out at a checkout counter. The settlement processing includes a process of calculation of the amount of the transaction between the commercial facility and the customer from the price and quantity of each product purchased by the customer, and a process in which the commercial facility receives currency from the customer for the amount of the transaction. In addition, if the amount of currency received by the commercial facility from the customer exceeds the amount of the transaction, the settlement processing includes the process of the commercial facility returning currency corresponding to the difference of the amount of currency received minus the amount of the transaction to the customer as change.

In the case where a store clerk at a commercial facility carries out from reading the bar code of the product to the settlement processing, the currency processing device 10 and the terminal device 20 function as a manned register. On the other hand, in the case where the customer himself/herself carries out from reading the bar code of the product to the settlement processing, the currency processing device 10 and the terminal device 20 function as a self-checkout register. In the case where a store clerk at a commercial facility reads the bar code of the product and a customer carries out the settlement processing, the currency processing device 10 and the terminal device 20 function as a semi-self-checkout register.

On the other hand, in a restaurant, when a clerk performs from the product selection to the settlement processing, the currency processing device 10 and the terminal device 20 function as a manned register. In the case where a customer himself/herself carries out from the product selection to the settlement processing, the currency processing device 10 and the terminal device 20 function as a self-checkout register. In the case where a clerk at a restaurant selects the product and a customer carries out the settlement processing, the currency processing device 10 and the terminal device 20 function as a semi-self-checkout register.

In the settlement processing, the currency processing device 10 functions as a change machine. Specifically, the currency processing device 10 executes the deposit processing of the money paid by the customer and contains the currency that is greater than the amount of the transaction in the device. If the amount deposited exceeds the amount of the transaction, the currency processing device 10 executes the withdrawal processing and pays out the difference in the amount obtained by subtracting the amount of the transaction from the amount deposited as change.

Then, the currency processing device 10 can be switched between a manned mode that allows the clerks of commercial facilities and restaurants to perform the settlement processing when the currency processing device 10 and the terminal device 20 function as a manned register, and a self-mode that allows the customer to perform the settlement processing when the currency processing device 10 and the terminal device 20 function as a self-checkout register or semi-self-checkout register.

Next, the configuration of the currency processing device 10 will be described in detail.

The currency processing device 10 includes a coin processing device 100 that performs deposit and withdrawal processing of coins and a banknote processing device 200 that performs deposit and withdrawal processing of banknotes. The coins and banknotes received from customers are deposited into the coin processing device 100 and banknote processing device 200, and coins and banknotes are withdrawn as change from the coin processing device 100 and banknote processing device 200. The coin processing device 100 and the banknote processing device 200 can be exemplified, as shown in FIG. 1, to be arranged side by side. However, the coin processing device 100 and the banknote processing device 200 may be arranged vertically.

### «Coin Processing Device 100»

The coin processing device 100 includes a coin acceptance part 101 that accepts coins and a coin dispenser part 102 that dispenses coins. The coin acceptance part 101 and the coin dispenser part 102 are provided in the front portion of a casing 110.

In addition, the coin processing device 100 includes a deposit transport part 103 that transports the coins taken into the housing 110 by the coin acceptance part 101, and a coin identification part 104 that is provided in the middle of the deposit transport part 103 to identify the coins.

The coin processing device 100 also includes coin container parts 106 that contain coins by each denomination, and a withdrawal transport part 108 that transports coins from the coin container parts 106 to the coin dispenser part 102.

Moreover, the coin processing device 100 includes a branch part 105 in the middle of the deposit transport part 103, which guides the coins to be dispensed from the coin dispenser part 102, such as rejected coins, to the withdrawal transport part 108 based on the coin identification results by the coin identification part 104. The branch part 105 guides normal coins to the coin container parts 106.

The coin acceptance part 101, the coin dispenser part 102, the deposit transport part 103, the coin identification part 104, the branch part 105, the coin container parts 106 and the withdrawal transport part 108, etc. constitute a coin processing unit 115, and the coin processing unit 115 is configured so that it can be pulled out forward from the housing 110.

In addition, the coin processing device 100 includes a display part 112 in the front and upper portion of the housing 110 that displays information such as images and letters. The display part 112 can be exemplified as a liquid crystal display or an organic EL (Electro Luminescence) display.

In addition, the coin processing device 100 includes an operation part 113 that accepts operations from a user. The operation part 113 has a push button that turns the switch on when pressed. In the exemplary embodiment, as shown in FIG. 1, the operation part 113 has a first operation button 113a which is at the first from the left, a second operation button 113b which is at the second from the left, a third operation button 113c which is at the third from the left, a fourth operation button 113d which is at the fourth from the left, a fifth operation button 113e which is at the fifth from the left, and a sixth operation button 113f which is at the sixth from the left. In the following, the first operation button 113a, the second operation button 113b, the third operation button 113c, the fourth operation button 113d, the fifth operation button 113e, and the sixth operation button 113f are collectively referred to as “operation button 113z” in some cases where it is not necessary to distinguish among them. When the operation button 113z is pressed, an operation control part 124, which will be described later, detects that the operation button 113z has been pressed.

In addition, the coin processing device 100 includes a locking mechanism 117 that prevents the coin processing unit 115 from being pulled out. When a key 118 is inserted into the locking mechanism 117 and rotated to a predetermined release position, the lock is released, and the user can pull out the coin processing unit 115. Moreover, when the key 118 is inserted into the locking mechanism 117 and rotated to a predetermined management position, the coin processing device 100 is placed in the management mode, which will be described later.

In addition, the coin processing device 100 includes a coin control part 120 that controls the coin acceptance part 101, the coin dispenser part 102, the deposit transport part 103, the coin container parts 106, the withdrawal transport part 108, etc.

The coin control part 120 is configured with a CPU (Central Processing Unit), a ROM and a RAM. The ROM stores basic programs (operating system) executed by the CPU, various types of settings, etc. The CPU uses the RAM as the work area and executes application programs read from the ROM.

The coin control part 120 includes a coin receiving part 121 that receives information sent from a banknote control part 220, which will be described later, and a coin sending part 122 that sends information to the banknote control part 220. The coin control part 120 also includes a display control part 123 that controls the display part 112 and the operation control part 124 that controls whether or not to accept operations to the operation part 113. The coin control part 120 further includes a processing control part 125 that performs various processing such as deposit processing, withdrawal processing, collection processing, replenishment processing, currency exchange processing, inspection processing, etc. In addition, the coin control part 120 includes a coin grasp part 126 that grasps the state of the coin acceptance part 101, the coin dispenser part 102, the deposit transport part 103, the coin container parts 106, the withdrawal transport part 108, etc. Moreover, the coin control part 120 includes an operation mode switching part 127 that switches the operation mode of the currency processing device 10 between the manned mode and the self-mode, and a management mode switching part 128 that switches the currency processing device 10 to the management that allows an administrator to perform management.

Signals from various sensors, such as a coin jam sensor 111 installed in the coin processing device 100 that detects coin jams, are entered into the coin grasp part 126. The coin jam sensor 111 is installed, for example, in the deposit transport part 103 and the withdrawal transport part 108 to detect the coin jam. Consequently, the coin grasp part 126 grasps occurrence of the coin jam and where in the housing 110 the coin jam occurs. In addition, a signal indicating that various sensors are dirty is entered into the coin grasp part 126. This allows the coin grasp part 126 to grasp which sensor is dirty. When grasping that the coins are jammed or that various sensors are dirty, the coin grasp part 126 outputs the information to the display control part 123.

The operation mode switching part 127 reads the setting of the manned mode or the self-mode stored in the ROM in advance and sets the operation mode of the currency processing device 10 to the manned mode or the self-mode. For example, it can be exemplified that, prior to installing the currency processing device 10 in a commercial facility or a restaurant, the manned mode or self-mode setting can be stored in the ROM depending on the type of use.

Note that it may be possible for the currency processing device 10 to have a physical switch that can physically switch between the manned mode and the self-mode, and for the operation mode switching part 127 to switch between the manned mode and the self-mode depending on the state of the physical switch.

In the case where the management mode switching part 128 detects that the key 118 is inserted into the lock mechanism 117 and rotated to the predetermined management position, the management mode switching part 128 switches from a non-management mode, which is not the management mode, to the management mode. The management mode switching part 128 outputs the information of switching to the management mode to the display control part 123 and the operation control part 124. In addition, the management mode switching part 128 stores the information of being the management mode in a storage area predetermined in the RAM for storing either of the management mode or the non-management mode. Note that, when the key 118 has not been rotated to the management position or the release position, the management mode switching part 128 stores the information of being the non-management mode in the storage area provided for storing either of the management mode or the non-management mode.

### «Banknote Processing Device 200»

The banknote processing device 200 includes a banknote acceptance part 201 that accepts banknotes and a banknote dispenser part 202 that dispenses banknotes. The banknote acceptance part 201 and the banknote dispenser part 202 are provided in the front portion of a casing 210.

In addition, the banknote processing device 200 includes an annular circulating transport part 203 provided substantially in the center portion of the housing 210 and transporting the banknotes taken into the housing 210 by the banknote acceptance part 201. The banknote processing device 200 also includes: a banknote identification part 204 provided in the middle of the circulating transport part 203 and identifying banknotes; and banknote container parts containing banknotes by each denomination. Moreover, the banknote processing device 200 includes a withdrawal rejection part 207 and a banknote collection cassette 208. The banknote processing device 200 also includes plural connection transport parts 209 connecting the circulating transport part 203 to the banknote acceptance part 201, the banknote dispenser part 202, the banknote container parts 206, the withdrawal rejection part 207, and the banknote collection cassette 208, respectively. In addition, the banknote processing device 200 includes a route switching part provided between the circulating transport part 203 and each connection transport part 209 to switch transport routes for the banknotes.

The banknote acceptance part 201, the banknote dispenser part 202, the withdrawal rejection part 207 and the banknote collection cassette 208 are provided in the front portion of the housing 210. In addition, the banknote acceptance part 201, the banknote dispenser part 202, the circulating transport part 203, the banknote container parts 206, the withdrawal rejection part 207, the banknote collection cassette 208 and the connection transport parts 209, etc. constitute a banknote processing unit 215, and the banknote processing unit 215 is configured so that it can be pulled out forward from the housing 210. Moreover, the banknote collection cassette 208 is detachably attached to the housing 210.

The banknote acceptance part 201 takes in the deposited banknotes inserted into a banknote acceptance slot 201a and lets the banknotes out one by one to the circulating transport part 203 side. Each banknote container part 206 stores the banknotes by each denomination based on the identification result of the banknote identification part 204. The banknote dispenser part 202 ejects the banknotes, which have been released to the circulating transport part 203 from each of the banknote container parts 206, out of the housing 210 from a banknote take-out slot 202a.

The withdrawal rejection part 207 stores banknotes that cannot be identified by the banknote identification part 204 due to skew, etc., among the banknotes discharged from the banknote container parts 206 as withdrawal-rejected banknotes. Among the banknotes taken from the banknote acceptance part 201 into the housing 201, banknotes that cannot be identified by the banknote identification part 204 due to defacement, etc., are returned to the banknote dispenser part 202 as deposit-rejected banknotes.

In addition, the banknote processing device 200 includes a locking mechanism 217 that prevents the banknote processing unit 215 from being pulled out. When a key 218 is inserted into the locking mechanism 217 and rotated to a predetermined release position, the lock is released, and the user can pull out the banknote processing unit 215.

Moreover, the banknote processing device 200 includes a banknote control part 220 that controls the banknote acceptance part 201, the banknote dispenser part 202, the circulating transport part 203, the banknote container parts 206, the connection transport parts 209, etc.

The banknote control part 220 is configured with a CPU (Central Processing Unit), a ROM and a RAM. The ROM stores basic programs (operating system) executed by the CPU, various types of settings, etc. The CPU uses the RAM as the work area and executes application programs read from the ROM.

The banknote control part 220 includes a banknote receiving part 221 that receives information sent from the terminal device 20, and a banknote sending part 222 that sends information to the coin control part 120 and the terminal device 20. The banknote control part 220 further includes a processing control part 225 that performs various processing such as deposit processing, withdrawal processing, collection processing, replenishment processing, currency exchange processing, inspection processing, etc. In addition, the banknote control part 220 includes a banknote grasp part 226 that grasps the state of the banknote acceptance part 201, the banknote dispenser part 202, the circulating transport part 203, the banknote container parts 206, the connection transport parts 209, etc.

The banknote sending part 222 sends the state of the coin processing device 100 sent from the coin sending part 122 of the coin control part 120 to the terminal device 20. The banknote sending part 222 also sends the information sent from the terminal device 20 to the coin receiving part 121 of the coin control part 120.

Signals from various sensors, such as a banknote jam sensor 211 installed in the banknote processing device 200 that detects banknote jams, are entered into the banknote grasp part 226. The banknote jam sensor 211 is installed, for example, in the circulating transport part 203 and the connection transport parts 209 to detect the banknote jam. Consequently, the banknote grasp part 226 grasps that the banknote jam has occurred and where in the housing 210 the banknote jam occurs. In addition, a signal indicating that various sensors are dirty is entered into the banknote grasp part 226. This allows the banknote grasp part 226 to grasp which sensor is dirty. When grasping that the banknotes are jammed or that various sensors are dirty, the banknote grasp part 226 outputs the information to the display control part 123 via the banknote sending part 222 or the coin receiving part 121.

### [Processing During Non-Management Mode]

### «Display Control Part 123»

The control performed by the display control part 123 when the currency processing device 10 is in the non-management mode will be described below.

The display control part 123 displays the standby screen G on the display part 112 during standby for a command to be received from the terminal device 20.

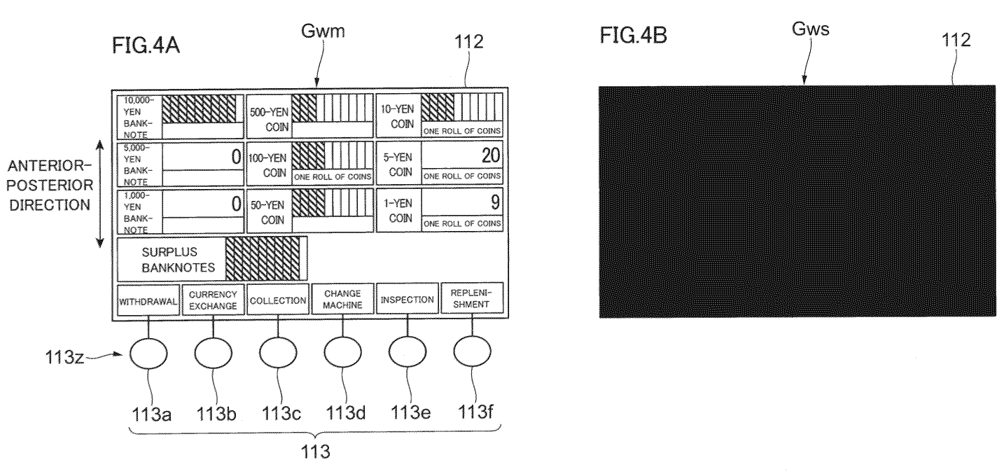

FIG. 4A is a diagram showing an example of a standby screen Gwm in the manned mode. FIG. 4B is a diagram showing an example of a standby screen Gws in the self-mode.

When the operation mode of the currency processing device 10 is the manned mode, in other words, the operation mode switching part 127 is switched to the manned mode and waiting for receiving a command from the terminal device 20, the display control part 123 displays the standby screen Gwm shown in FIG. 4A on the display part 112.

The display control part 123 displays an amount of coins and banknotes in stock inside the coin processing device 100 and banknote processing device 200 on the standby screen Gwm.

In addition, the display control part 123 displays a text indicating the processing contents when the operation button 113z of the operation part 113 is pressed at an end portion on a side where the operation part 113 is provided in the standby screen Gwm. For example, the display control part 123 displays the word “Withdrawal” at a position corresponding to the first operation button 113a in the left-right direction (for example, a position overlapping in the anterior-posterior direction), displays the word “Currency Exchange” at a position corresponding to the second operation button 113b, and displays the word “Collection” at a position corresponding to the third operation button 113c. The display control part 123 also displays, in the left-right direction, the words “Change Machine” at a position corresponding to the fourth operation button 113d, displays the word “Inspection” at a position corresponding to the fifth operation button 113e, and displays the word “Replenishment” at a position corresponding to the sixth operation button 113f.

On the other hand, in the case where the operation mode of the currency processing device 10 is the self-mode, in other words, the operation mode switching part 127 is switched to the self-mode, the display control part 123 displays nothing on the display part 112 during standby as shown in FIG. 4B. Therefore, the state in which nothing is shown on the display part 112 is the standby screen Gws. In this way, by not displaying anything on the standby screen Gws, there is no need to provide a cover for the display part 112. In addition, the display control part 123 can reduce the power consumption by turning off the power to the display part 112 so that nothing is displayed on the standby screen Gws.

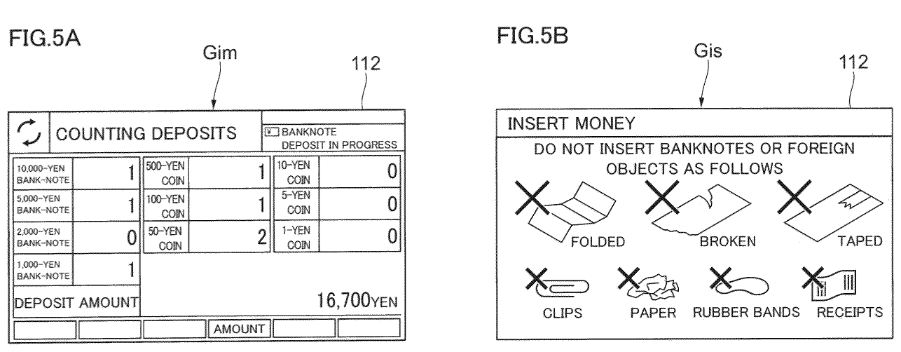

FIG. 5A is a diagram showing an example of a deposit screen Gim in the manned mode. FIG. 5B is a diagram showing an example of a deposit screen Gis in the self-mode.

In the case where the currency processing device 10 is in the manned mode, and in the case where a command is received from the terminal device 20 and deposit processing is to be performed in which insertion of money larger than the settlement amount included in the command is prompted, the display control part 123 displays a deposit screen Gim showing deposit guidance for a store clerk on the display part 112.

For example, as shown in FIG. 5A, the display control part 123 displays the words “Counting Deposits” and the number of coins and banknotes inserted by each denomination on the deposit screen Gim. In addition, the total amount of coins and banknotes inserted is displayed as “Deposit Amount”.

On the other hand, in the case where the currency processing device 10 is in the self-mode and the deposit processing is to be performed, the display control part 123 displays a deposit screen Gis showing deposit guidance for a customer on the display part 112.

For example, as shown in FIG. 5B, the display control part 123 causes the display part 112 to display the words “Insert Money” on the deposit screen Gis to prompt the customer to insert money. In addition, the display control part 123 causes the display part 112 to show images and letters of banknotes and foreign objects that should not be inserted, along with the words “Do Not Insert Banknotes or Foreign Objects as follows” on the deposit screen Gis. Note that, in the case where the terminal device 20 is installed so that the customer can see the terminal device 20, and images and letters of banknotes and foreign objects that should not be inserted are displayed on the terminal device 20, the display control part 123 may not display anything on the display part 112.

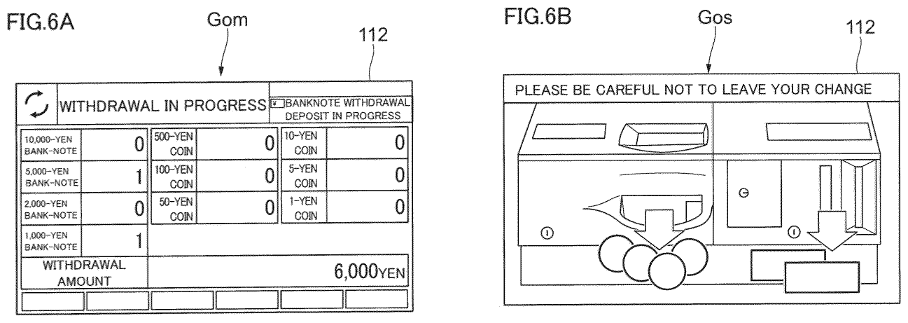

FIG. 6A is a diagram showing an example of a withdrawal screen Gom in the manned mode. FIG. 6B is a diagram showing an example of a withdrawal screen Gos in the self-mode.

In the case where the currency processing device 10 is in the manned mode, and when the total amount of coins or banknotes inserted exceeds the settlement amount and withdrawal processing for returning change is to be performed, the display control part 123 displays the withdrawal screen Gom showing the withdrawal guidance for the store clerk on the display part 112.

For example, as shown in FIG. 6A, display control part 123 displays the words “Withdrawal in Progress” and the number of coins and banknotes of each denomination to be returned on the withdrawal screen Gom. In addition, the total amount of money to be returned is displayed as “Withdrawal Amount”.

Note that when the currency processing device 10 is in the manned mode, it can be exemplified that the withdrawal processing is performed when an instruction to withdraw change is received from the terminal device 20 or when the first operation button 113a is pressed.

On the other hand, in the case where the currency processing device 10 is in the self-mode and the withdrawal processing is to be performed, the display control part 123 displays a withdrawal screen Gos showing withdrawal guidance for a customer on the display part 112.

For example, as shown in FIG. 6B, the display control part 123 displays the words “Please Be Careful Not to Leave Your Change” and an image showing where coins and banknotes are returned as change on the withdrawal screen Gos.

Note that, when the currency processing device 10 is in the self-mode, it can be exemplified that the withdrawal processing is performed automatically, assuming that the deposit is confirmed when the total amount of coins or banknotes inserted exceeds the settlement amount. Alternatively, when the terminal device 20 installed to be operable by the customer, it can be exemplified that the withdrawal processing is performed assuming that the deposit is confirmed when an instruction to withdraw change is received from the terminal device 20.

In addition, if the terminal device 20 is installed so that the customer can see the terminal device 20 and the words “Please Be Careful Not to Leave Your Change” are displayed on the terminal device 20, the display control part 123 may not display anything on the display part 112.

Note that the display control part 123 displays the standby screen Gwm on the display part 112 when the currency processing device 10 is in the manned mode and coins or banknotes returned as change are taken. Similarly, the display control part 123 displays the standby screen Gws on the display part 112 when the currency processing device 10 is in the self-mode and coins or banknotes returned as change are taken.

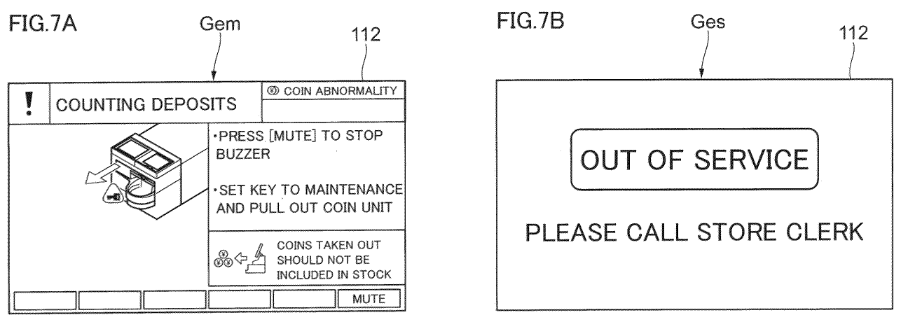

FIG. 7A is a diagram showing an example of an abnormality notification screen Gem in the manned mode. FIG. 7B is a diagram showing an example of an abnormality notification screen Ges in the self-mode.

In the case where the currency processing device 10 is in the manned mode and an abnormality occurs during the deposit processing or withdrawal processing, the display control part 123 shows the abnormality notification screen Gem for the store clerk on the display part 112.

For example, as shown in FIG. 7A, the display control part 123 causes the display part 112 to display, on the abnormality notification screen Gem, images and letters notifying the details of the abnormality, the area where the abnormality occurred, and how to resolve the abnormality. FIG. 7A exemplifies an abnormality notification screen Gem in the case where an abnormality such as a coin jam occurs in the deposit transport part 103 of the coin processing device 100.

On the other hand, in the case where the currency processing device 10 is in the self-mode and an abnormality occurs during the deposit processing or withdrawal processing, the display control part 123 shows the abnormality notification screen Ges for the customer on the display part 112.

For example, as shown in FIG. 7B, the display control part 123 causes the display part 112 to display the words “Out of Service” and “Please Call Store Clerk” on the abnormality notification screen Ges to prompt the customer to call a store clerk.

As described above, when the currency processing device 10 is in the non-management mode, the display control part 123 changes the display mode on the display part 112 between the manned mode and the self-mode.

### «Operation Control Part 124»

The control performed by the operation control part 124 when the currency processing device 10 is in the non-management mode will be described below.

### (Manned Mode)

The operation control part 124 accepts the operation of the operation part 113 when the currency processing device 10 is in the manned mode. Then, when the operation control part 124 detects that the operation button 113z has been pressed during standby, the operation control part 124 outputs the information that the operation button 113z has been pressed to the display control part 123 and the processing control part 125. In addition, the operation control part 124 outputs to the information that the operation button 113z has been pressed to the processing control part 225 through the coin sending part 122 and the banknote receiving part 221.

For example, when the second operation button 113b has been pressed during standby, the operation control part 124 outputs the information that the second operation button 113b has been pressed to the display control part 123. When the display control part 123 obtains an output that the second operation button 113b has been pressed, the display control part 123 displays a currency exchange screen on the display part 112 instead of the standby screen Gwm. At least one of the processing control part 125 and the processing control part 225 executes the currency exchange processing corresponding to the operation button 113z pressed when the display part 112 displays the currency exchange screen. For example, when the processing control part 225 receives an output indicating that the operation button 113z instructing currency exchange has been pressed and accepts insertion of 5,000 yen, the processing control part 225 dispenses five 1,000-yen banknotes instead of a single 5,000-yen banknote inserted.

In addition, when the fifth operation button 113e has been pressed during standby, the operation control part 124 outputs the information that the fifth operation button 113e has been pressed to the display control part 123. When the display control part 123 obtains an output that the fifth operation button 113e has been pressed, the display control part 123 displays a screen for inspection on the display part 112 instead of the standby screen Gwm. At least one of the processing control part 125 and the processing control part 225 executes the inspection processing corresponding to the operation button 113z pressed when the display part 112 displays the inspection screen. For example, when the processing control part 225 receives an output that the operation button 113z, which instructs the inspection of a 10,000-yen banknote, is pressed, the processing control part 225 performs the inspection of the 10,000-yen banknote contained in the banknote container part 206.

In addition, when the sixth operation button 113f has been pressed during standby, the operation control part 124 outputs the information that the sixth operation button 113f has been pressed to the display control part 123. When the display control part 123 obtains an output that the sixth operation button 113f has been pressed, the display control part 123 displays a screen for replenishment on the display part 112 instead of the standby screen Gwm. At least one of the processing control part 125 and the processing control part 225 executes the replenishment processing corresponding to the operation button 113z pressed when the display part 112 displays the replenishment screen. For example, when the processing control part 125 receives an output that the control button 113z, which instructs replenishment of 10 yen coins, is pressed, the inserted 10 yen is contained in the coin container part 106.

In addition, when the fourth operation button 113d has been pressed during standby, the operation control part 124 outputs the information that the fourth operation button 113d has been pressed to the display control part 123. When the display control part 123 obtains the output that the fourth operation button 113d has been pressed, the display control part 123 displays a screen that enables confirmation of setting changes and history of the currency processing device 10 on the display part 112 instead of the standby screen Gwm. Note that it may be possible to perform setting changes only in the management mode, which will be described later.

For example, if the first operation button 113a is pressed after at least one of the processing control part 125 and the processing control part 225 has performed the deposit processing, the operation control part 124 outputs the information that the first operation button 113a has been pressed to the display control part 123, the processing control part 125, and the processing control part 225. Then, the display control part 123 displays the withdrawal screen Gom on the display part 112 when the display control part 123 receives the output that the first operation button 113a has been pressed. At least one of the processing control part 125 and the processing control part 225 performs the withdrawal processing.

Note that, in the case of the non-management mode, the operation control part 124 prevents the operation of the third operation button 113c from being accepted even though the third operation button 113c corresponding to the collection processing has been pressed during standby. In other words, the operation control part 124 disables the operation of the third operation button 113c. This is to prevent a person other than the administrator from allowing the currency processing device 10 to perform the collection processing.

### (Self-Mode)

The operation control part 124 does not accept the operation of the operation part 113 when the currency processing device 10 is in the self-mode. That is, for example, even though the operation control part 124 detects that the operation button 113z has been pressed during standby, the operation control part 124 does not output the information that the operation button 113z has been pressed to the display control part 123, the processing control part 125, and the processing control part 225. Therefore, for example, the display control part 123 does not display the above-described screen for collection on the display part 112 with the third operation button 113c having been pressed as an impetus. In addition, the processing control part 125 and the processing control part 225 do not perform collection processing with the third operation button 113c having been pressed as an impetus.

For example, even though the first operation button 113a is pressed after at least one of the processing control part 125 and the processing control part 225 has performed the deposit processing, the operation control part 124 does not output the information that the first operation button 113a has been pressed to the display control part 123, the processing control part 125, and the processing control part 225. Therefore, at least one of the processing control part 125 and the processing control part 225 does not perform collection processing with the first operation button 113a having been pressed as an impetus.

### «Processing Control Part 125 and Processing Control Part 225»

Regardless of whether the currency processing device 10 is in the management mode or the non-management mode, and regardless of whether the currency processing device 10 is in the manned mode or the self-mode, the processing control part 125 controls the deposit transport part 103, the coin container parts 106, the withdrawal transport part 108, etc., and the processing control part 225 controls the circulating transport part 203, the banknote container parts 206, the connection transport parts 209, etc., to thereby perform various processing such as the deposit processing, the withdrawal processing, etc.

In addition, in the case where the currency processing device 10 is in the non-management mode and in the self-mode, the processing control part 125 performs the following processing.

For example, the processing control part 125 intermittently drives a feeding belt of the coin acceptance part 101 during the deposit processing. This prevents coins inserted into the coin acceptance part 101 from staying.

In addition, in the case where the processing control part 125 receives an output from a sensor that detects the insertion of coins into the coin acceptance part 101 indicating that the insertion of coins into the coin acceptance part 101 is detected during standby, the processing control part 125 operates the deposit transport part 103, the branch part 105, and the withdrawal transport part 108 to forcibly transport the deposited coins to the coin dispenser part 102. This makes it possible, in the case of the self-mode, to return coins that have been accidentally inserted by a customer to the customer without bothering the administrator, for example. In addition to returning the coins, the terminal 20 is notified that the coins have been inserted. As a result, the terminal 20 can notify the customer that the insertion was a mistake.

In addition, after the deposit is confirmed while total amount of coins and banknotes inserted exceeds the settlement amount, etc., the processing control part 125 operates the deposit transport part 103, the branch part 105, and the withdrawal transport part 108 to forcibly transport the further inserted coins to the coin dispenser part 102. Moreover, after the deposit is confirmed, the processing control unit 225 operates the banknote dispenser part 202 and the circulating transport part 203 to forcibly transport the further inserted banknotes to the banknote take-out slot 202a. This makes it possible, in the case of the self-mode, to return coins and banknotes that have been unnecessarily inserted by a customer to the customer without bothering the administrator, for example.

### [Processing During Management Mode]

Even though the currency processing device 10 is in the self-mode, if the key 118 is inserted into the locking mechanism 117 and the key 118 is rotated to the management position, the currency processing device 10 switches to the management mode that allows the administrator to manage thereof. In other words, even in the case where the operation mode switching part 127 switches the operation mode of the currency processing device 10 to the self-mode, if the management mode switching part 128 switches to the management mode, the currency processing device 10 switches to the management mode.

Even in the case where the currency processing device 10 is in the self-mode, when the currency processing device 10 is switched to the management mode, the display control part 123 displays the screen in the case of the manned mode on the display part 112. For example, in the case where the currency processing device 10 is in the self-mode and in the management mode, the display control part 123 displays the standby screen Gwm for the manned mode during standby, the deposit screen Gim for the manned mode when performing the deposit processing, the withdrawal screen Gom for the manned mode when performing the withdrawal processing, and the abnormality notification screen Gem for the manned mode when an abnormality occurs.

Even in the case where the currency processing device 10 is in the self-mode, when the currency processing device 10 is switched to the management mode, the operation control part 124 accepts the operation to the operation part 113 in the same manner as in the manned mode. The processing performed by the operation control part 124, the display control part 123, the processing control part 125, and the processing control part 225 in the case where the operation control part 124 detects that the operation button 113z has been pressed is the same as the processing in the manned mode described above; therefore, a detailed description thereof will be omitted.

Note that, even in the case where the currency processing device 10 is in the manned mode, when the key 118 is rotated to the management position, the currency processing device 10 switches to the management mode. In other words, even in the case where the operation mode switching part 127 switches the operation mode of the currency processing device 10 to the manned mode, if the management mode switching part 128 switches to the management mode, the currency processing device 10 switches to the management mode.

In the case where the currency processing device 10 is in the manned mode, when the currency processing device 10 is switched to the management mode, the display control part 123 displays the screen in the case of the management mode on the display part 112. In the case of manned mode and management mode, it can be exemplified that the screen is in the manned mode described above, which is also similar to the case of non-management mode. Moreover, the processing performed by the operation control part 124, the display control part 123, the processing control part 125, and the processing control part 225 in the case where the operation control part 124 detects that the operation button 113z has been pressed accepts the collection processing in addition to the processing in the manned mode. For example, in the case of the management mode, when the third operation button 113c has been pressed during standby, the operation control part 124 outputs the information that the third operation button 113c has been pressed to the display control part 123. When the display control part 123 obtains an output that the third operation button 113c has been pressed, the display control part 123 displays a screen for collection on the display part 112 instead of the standby screen Gwm. At least one of the processing control part 125 and the processing control part 225 executes the collection processing corresponding to the operation button 113z pressed when the display part 112 displays the collection screen. For example, when the processing control part 125 receives an output that the operation button 113z, which instructs the collection of 100 yen coins, is pressed, the processing control part 125 dispenses all 100 yen coins contained in the coin container part 106.

For example, it may be possible for the display control part 123 to display the above-mentioned standby screen Gwm for the manned mode on the display part 112 during standby in the case of the manned mode and the management mode, and to display a simplified screen of the standby screen Gwm for the manned mode on the display part 112 in the case of the manned mode and the non-management mode.

As described above, the currency processing device 10 includes the operation part 113 that accepts operations performed by a user, and the operation mode switching part 127 that switches between the manned mode as an example of a first mode in which a store clerk is allowed to perform settlement processing, and a self-mode as an example of a second mode in which a customer is allowed to perform the settlement processing. The currency processing device 10 also includes the operation control part 124 that performs control so that operations are accepted in the operation part 113 in the manned mode, and operations are not accepted in the operation part 113 in the self-mode.

According to the currency processing device 10 configured in this way, it is not necessary to provide a cover for the operation part 113 to prevent operation to the operation part 113 in the case of the self-mode to be operated as a self-checkout register. Therefore, it is possible to inexpensively realize that operations of the operation part by a customer are not effective.

In addition, the currency processing device 10 includes the management mode switching part 128 that switches to the management mode to allow the administrator to manage, and the operation control part 124 performs control to accept operations to the operation part 113 in the case of the management mode even in the self-mode. This allows the administrator to insert the key 118 into the locking mechanism 117 and rotate the key 118 to the management position, even if the currency processing device 10 is set to the self-mode; therefore it is possible to carry out various processing such as collection processing, replenishment processing, currency exchange processing, and inspection processing.

The currency processing device 10 further includes the display part 112 that displays information, and the display control part 123 that causes the display part 112 to display information in the manned mode and not to display information in the self-mode. When the currency processing device 10 is in non-management mode and is in the self-mode, for example, by not causing the display part 112 to display anything on the standby screen Gws in the self-mode, the words corresponding to the operation button 113z, which are displayed on the standby screen GWM in the manned mode, are not displayed; consequently, it becomes possible to prevent the customer from operating the operation part 113.

In addition, when an abnormality occurs, the display control part 123 displays the occurrence of the abnormality on the display part 112 in a different manner between the manned mode and the self-mode (refer to the abnormality notification screen Gem and the abnormality notification screen Ges in FIG. 7B). This makes it possible to perform the appropriate display for each mode.

In addition, the display control part 123 causes the display part 112 to display guidance on at least one of the deposit and the withdrawal in a different manner between the manned mode and the self-mode. This makes it possible to realize the appropriate display for each mode.

### Second Exemplary Embodiment

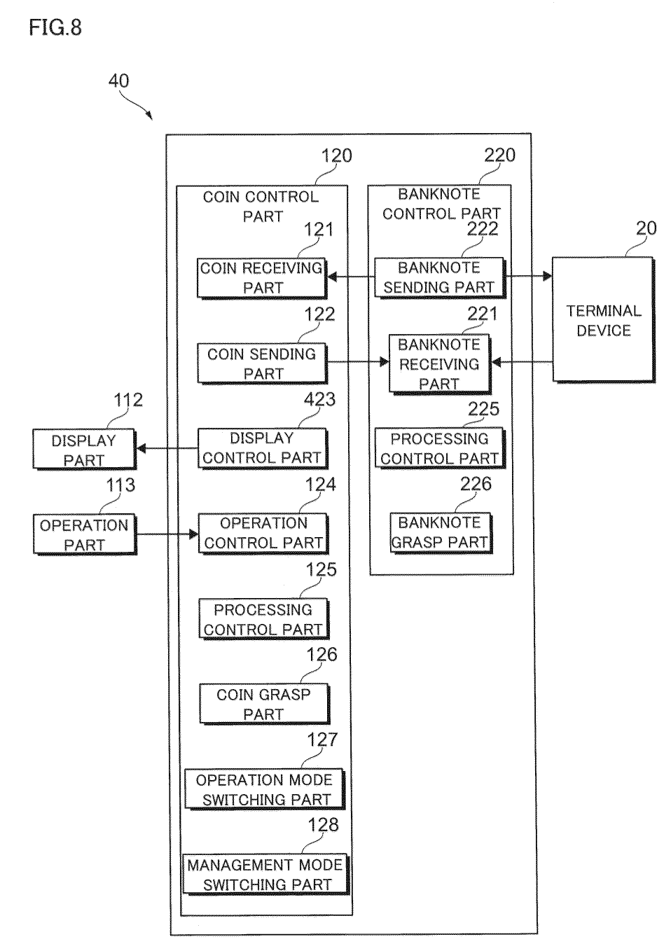

FIG. 8 is a block diagram showing an example of a functional configuration of a currency processing device 40.

The currency processing device 40 is different in a display control part 423 corresponding to the display control part 123 from the currency processing device 10. In the first and second exemplary embodiments, the same reference signs are assigned to components having the same functions, and detailed descriptions thereof are omitted.

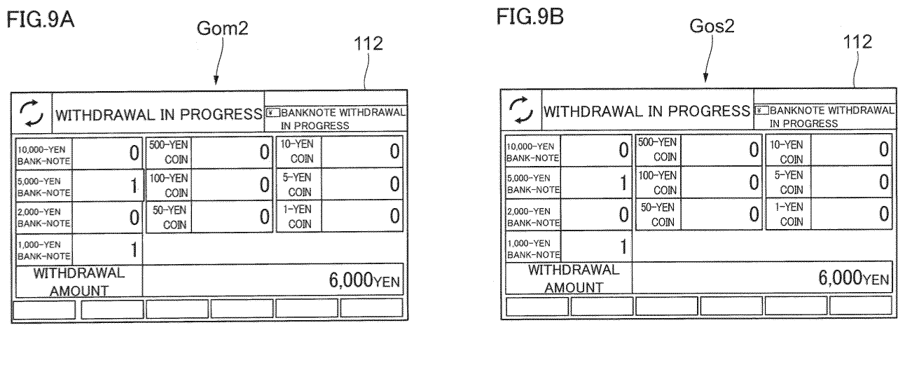

FIG. 9A is a diagram showing an example of a withdrawal screen Gom2 in the manned mode. FIG. 9B is a diagram showing an example of a withdrawal screen Gos2 in the self-mode.

The display control part 423 differs from the display control part 123 in that the screen displayed on the display part 112 in the case of the non-management mode and in the case of performing the withdrawal processing is the same in the manned mode and in the self-mode.

More specifically, in the case of the non-management mode and in the case of performing the withdrawal processing, the display control part 423 causes the display part 112 to display a screen as the withdrawal screen Gom2 for the manned mode, which is similar to the withdrawal screen Gom displayed by the display control part 123. In addition, in the case of the non-management mode and in the case of performing the withdrawal processing, the display control part 423 causes the display part 112 to display a screen as the withdrawal screen Gos2 for the self-mode, which is similar to the withdrawal screen Gom2. In other words, the display control part 423 displays the words “Withdrawal in Progress”, the number of banknotes to be returned by each denomination, and the total amount of money to be returned as

As described above, in the currency processing device 40, the display control part 423 causes the display part 112 to display the deposit guidance in a different manner between the manned mode and the self-mode, and to display the withdrawal guidance in the same manner between the manned mode and the self-mode. This makes it easier for the customer to grasp what denomination and how much to take as change from the coin dispenser part 102 or the banknote dispenser part 202.

### Third Exemplary Embodiment

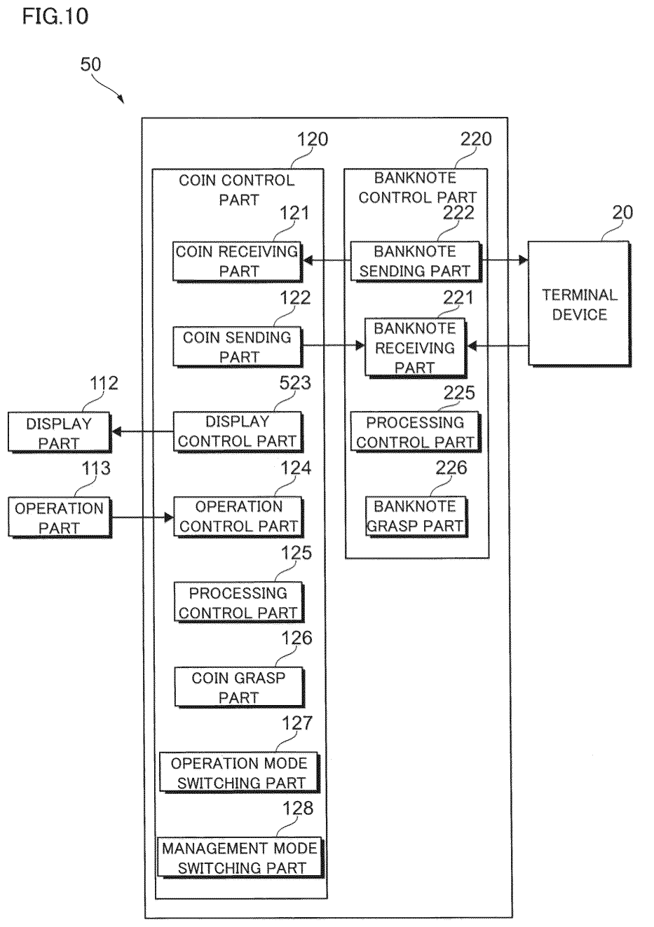

FIG. 10 is a block diagram showing an example of a functional configuration of a currency processing device 50.

The currency processing device 50 is different in a display control part 523 corresponding to the display control part 123 from the currency processing device 10. In the first and third exemplary embodiments, the same reference signs are assigned to components having the same functions, and detailed descriptions thereof are omitted.

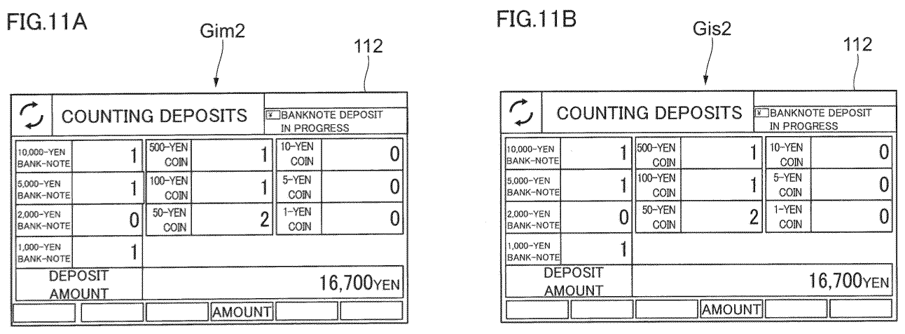

FIG. 11A is a diagram showing an example of a deposit screen Gim2 in the manned mode. FIG. 11B is a diagram showing an example of a deposit screen Gis2 in the self-mode.

The display control part 523 differs from the display control part 123 in that the screen displayed on the display part 112 in the case of the non-management mode and in the case of performing the deposit processing is the same in the manned mode and in the self-mode.

More specifically, in the case of the non-management mode and in the case of performing the deposit processing, the display control part 523 causes the display part 112 to display a screen as the deposit screen Gim2 for the manned mode, which is similar to the deposit screen Gim displayed by the display control part 123. In addition, in the case of the non-management mode and in the case of performing the deposit processing, the display control part 523 causes the display part 112 to display a screen as the deposit screen Gis2 for the self-mode, which is similar to the deposit screen Gim. In other words, the display control part 523 displays the words “Counting Deposits” and the number of coins and banknotes inserted by each denomination on the deposit screen Gim2 for the self-mode. In addition, the total amount of coins and banknotes inserted is displayed as “Deposit Amount”.

As described above, in the currency processing device 50, the display control part 523 causes the display part 112 to display the withdrawal guidance in a different manner between the manned mode and the self-mode, and to display the deposit guidance in the same manner between the manned mode and the self-mode. This makes it easier for the customer to grasp what denomination and how much has been inserted into the coin acceptance part 101 or the banknote acceptance part 201.

Note that, similar to the display control part 423 in the second exemplary embodiment, the display control part 523 may allow the screen displayed on the display part 112 to be the same between the manned mode and the self-mode in the case of the non-management mode and in the case of performing the withdrawal processing. In other words, the display control part 523 may have different screens to be displayed on the display part 112 during standby and when an abnormality occurs in the manned mode and in the self-mode, and the screen to be displayed on the display part 112 during deposit and withdrawal may be the same in the manned mode and in the self-mode.

1. A currency processing device comprising:
an operation part configured to accept an operation by a user;
an operation mode switching part configured to switch between a first mode in which a store clerk is allowed to perform settlement processing, and a second mode in which a customer is allowed to perform the settlement processing; and
an operation control part configured to control to accept the operation to the operation part in the first mode and not to accept the operation to the operation part in the second mode.

2. The currency processing device according to claim 1, further comprising:
a management mode switching part configured to switch to a management mode allowing an administrator to manage, wherein,
in a case of the management mode, the operation control part controls to accept the operation to the operation part even in a case of the second mode.

3. The currency processing device according to claim 1, further comprising:
a display part configured to display information; and
a display control part configured to control to cause the display part to display information in the first mode and not to display information in the second mode.

4. The currency processing device according to claim 3, wherein, when an abnormality occurs, the display control part causes the display part to display occurrence of the abnormality in a different manner between the first mode and the second mode.

5. The currency processing device according to claim 3, wherein, when performing deposit processing or withdrawal processing, the display control part causes the display part to display guidance on at least one of deposit and withdrawal in a different manner between the first mode and the second mode.

6. The currency processing device according to claim 3, wherein, when performing deposit processing or withdrawal processing, the display control part causes the display part to display guidance on one of deposit and withdrawal in a different manner between the first mode and the second mode and to display guidance on the other in the same manner in the first mode and in the second mode.

7. The currency processing device according to claim 1, further comprising:
a currency acceptance part configured to drive a feeding belt to accept currency; and,
a processing control part configured to intermittently drive the feeding belt when performing deposit processing in the second mode.

8. The currency processing device according to claim 1, further comprising:
a sensor configured to detect that currency has been inserted;
a transport part configured to transport currency; and
a processing control part configured to control the transport part to dispense currency when the sensor detects that the currency has been inserted during standby.

9. The currency processing device according claim 1, further comprising:
a depositing part configured to receive currency;
a transport part configured to transport currency; and
a processing control part configured to control, in the second mode, the transport part to dispense currency that has further been received after deposit is confirmed.

10. The currency processing device according to claim 2, wherein the management mode switching part switches to the management mode in response to a position where a key is inserted and rotated.

11. The currency processing device according to claim 1, wherein the operation mode switching part switches between the first mode and the second mode based on a preset setting.

12. A currency processing device comprising:
an operation part configured to accept an operation by a user;
an operation mode switching part configured to switch between a first mode in which a store clerk is allowed to perform settlement processing, and a second mode in which a customer is allowed to perform the settlement processing;
an operation control part configured to control to accept the operation to the operation part in the first mode and not to accept the operation to the operation part in the second mode;
a display part configured to display information; and
a display control part configured to control to cause the display part to display information in the first mode and not to display information in the second mode.

13. A currency processing device comprising:
an operation part configured to accept an operation by a user;
an operation mode switching part configured to switch between a first mode in which a store clerk is allowed to perform settlement processing, and a second mode in which a customer is allowed to perform the settlement processing;
an operation control part configured to control to accept the operation to the operation part in the first mode and not to accept the operation to the operation part in the second mode;
a depositing part configured to receive currency;
a transport part configured to transport currency; and
a processing control part configured to control, in the second mode, the transport part to dispense currency that has further been received after deposit is confirmed.
